(19) United States
(12) Patent Application Publication
(10) Pub. No.: US 2005/0015928 A1
(43) Pub. Date: Jan. 27, 2005

(54) Caster assembly

(76) Inventors: Gerald Arsenault, Pickering (CA); Jamie Templeton, Toronto (CA)

Correspondence Address: SIMPSON & SIMPSON, PLLC, 5555 MAIN STREET, WILLIAMSVILLE, NY, 14221-5406, US

(21) Appl. No.: 10/626,145

(22) Filed: Jul. 24, 2003

(51) Int. Cl. E05F 1/08

(52) U.S. Cl. 16/300

(57) ABSTRACT

An apparatus for attaching a wheeled element, such as a caster, comprises a caster bracket with means for engaging the caster plate of a caster. The caster is affixed to the caster plate and is then engaged with the caster bracket. The caster bracket is preferably flanged for slidably receiving the caster plate which is positively held in place with the aid of a flexible locking member affixed to the caster bracket. The flexible member is operatively arranged to substantially immobilize the caster plate when the member engages a surface of a slot in the caster plate. The flexible locking member further comprises a tab extension operatively arranged to allow disengagement of the caster safely by direct hand/finger engagement without requiring tools.

### FIELD OF THE INVENTION

This invention generally relates to an improved system for mounting wheels to an object for greater portability, and more specifically, to apparatus and assemblies for more convenient mounting and ease of removal of casters from furniture, and other articles of manufacture.

### BACKGROUND OF THE INVENTION

The need for a quick and convenient removable connection of a wheel from an object, such as a piece of furniture, is a well known problem. Heretofore, others have tried to address this problem by means of engaging a wheel to a bracket affixed to the object. U.S. Pat. No. 4,817,237 (Murphy), for example, discloses a bracket for engaging a caster plate and caster wheel to luggage. In order to slidably engage the caster plate into the bracket an abutment of a cantilevered arm is required to be depressed sufficiently by applying finger pressure to allow the caster plate to slide lengthwise into a channel. Likewise, the abutment must first be depressed by applying finger pressure to allow removal of the caster plate from the bracket. While the device is generally useful, the need to place the fingers in the path of a sliding caster plate to exert pressure against a stop during the instillation and removal processes is not only inconvenient, but also presents a risk of injury to the finger(s) which may be lacerated in the process. This can occur, for example, when the caster plate is slid into the channels to engage with the stop when needed to be held down in a depressed position using the fingers. Accordingly, while the '237 patent suggests the application of finger pressure in the installation and removal processes, actual performance of these manipulative steps without the aid of a hand tool may result in injury.

U.S. Pat. No. 4,843,678 (Park) discloses a caster bracket with four perpendicular flanges. A “U” shaped bar is threaded through holes in the four flanges after a caster plate is inserted proximate the caster bracket. Nuts are then applied to the threaded ends of the bar to hold the bar in place. This invention requires a wrench to apply the nuts, and the nuts and bar are separate pieces.

Clearly, then, there is a need for an improved system for mounting casters and caster assemblies having a minimal number of component parts that enables casters and other types of wheels to be easily and quickly affixed to an object, and also to be readily disengaged manually, safely and conveniently without actually requiring tools in the process.

### SUMMARY OF THE INVENTION

Generally, the present invention comprises an apparatus for attaching a caster to an object, wherein the caster can be readily and safely disengaged from its mounting bracket (and re-engaged) all without the aid of hand tools. More specifically, the apparatus comprises a caster bracket having flange means for forming a plurality of channels, preferably a bracket plate seated and affixed to the interior surface of the caster bracket, wherein the caster plate of a caster assembly can be introduced between the flange means and readily guided in place by the channels of the caster bracket and securely locked in place. One of the flanges of the caster bracket may function as a stop for the caster plate. The caster bracket also comprises a flexible member for engaging and securely retaining in place the caster plate of a caster assembly. The flexible member is operatively arranged to substantially immobilize the caster plate when the flexible member engages an edge of or a slot in the caster plate, securely locking the caster plate and caster wheel in place. The flexible member further comprises a tab operatively arranged to disengage the flexible member from the edge or slot in the caster plate when the tab is deflected. Preferably, the tab of the flexible member is adapted for direct manual operation by application of hand and/or finger pressure, so as to safely eliminate the requirement for tools. That is, the caster plate and caster wheel may be conveniently and safely released from the caster bracket by merely applying hand/finger pressure to the tab without injury occurring by extending the length of the tab, so when installing a caster or when removing a caster from the caster bracket hands and fingers are out of harms way. This may be achieved, for example, by extending the tab beyond a perimeter of the caster bracket. The tab extension also imparts leverage for releasing the caster plate of a caster assembly making full depression of the tab an easier, more convenient task to perform, allowing disengagement of the caster plate and wheel assembly from the bracket by hand without tools, i.e., by direct manual deflection of the tab. While the tab extension allows the application of greater force for depression of the tab the bracket plate protects the action of the flexible member from shear and/or possible loss of spring action.

Accordingly, it is a principal object of the present invention to provide a durable apparatus/hardware device for attaching a wheeled element, such as a caster to a surface of an object.

It is yet a further object of the invention to provide a device that allows quick and convenient attachment and disengagement of a caster plate and wheel assembly from a caster bracket mounted to the base of objects, such as furniture, for greater portability.

It is yet a further object of the invention to provide a hardware kit comprising all the essential components for achieving portability of an object, including the device for attaching a wheeled element to the surface of an object. Such hardware kits may also include a wheeled element, such as a caster.

These and other objects, features and advantages of the present invention will become readily apparent to those having ordinary skill in the art with reading the following detailed description of the invention in view of the drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a side elevational view of the caster assembly comprising an embodiment of the apparatus of the present invention shown with caster mounted to the base of a piece of furniture;

FIG. 2 is a side elevational view of the caster assembly of FIG. 1, showing the caster plate with caster being disengaged from the caster bracket;

FIG. 3 is a bottom plan view of a preferred embodiment of the caster bracket of the present invention;

FIG. 4 is an exploded view of the caster mounting assembly of the present invention including caster plate and caster;

FIG. 5 is a side sectional view taken along line 5-5 of FIG. 3, illustrating the caster bracket, bracket plate and flexible member assembly prior to installation of the caster;

FIG. 6 is also a side sectional view taken along line 5-5 of FIG. 3, illustrating the caster bracket, etc., taken along line 5-5 of FIG. 3, but with the flexible member deflected for showing disengagement and withdrawal of the caster plate, and

FIG. 7 is a front end view of the caster bracket of FIG. 5 of the present invention.

### DETAILED DESCRIPTION OF THE PREFERRED EMBODIMENT

It should be appreciated that in the detailed description of the invention which follows, like reference numbers on different drawing views are intended to identify identical structural elements of the invention in the respective views. The accompanying drawings illustrate wheels of the present invention. However, the particular wheel illustrated is merely representative of one type of caster which can be affixed to the base of a piece of furniture by means of the mounting apparatus of the invention. Accordingly, it will be readily apparent to one skilled in the art that the present invention can be used for mounting a wide range of wheel elements or casters of virtually any design or end-use application to various objects to achieve desired portability, such as cabinets, luggage, pianos, fixtures, dollies, trucks, hand carts, machinery, to name but a few. And, these variations and modifications are intended to be within the spirit and broad scope of the invention as claimed.

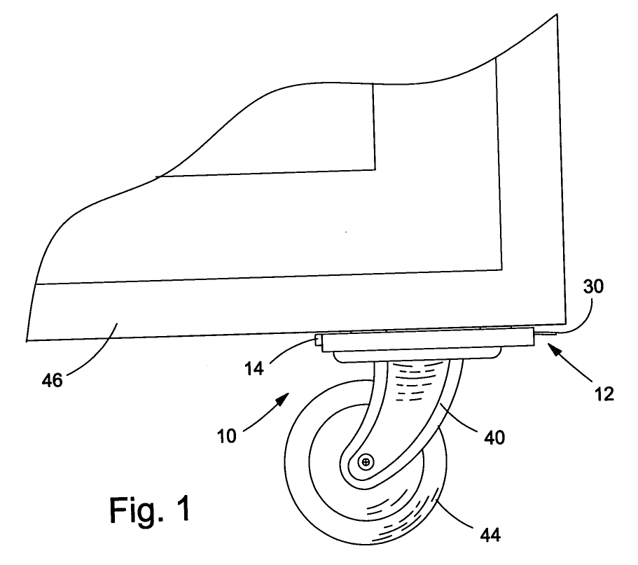

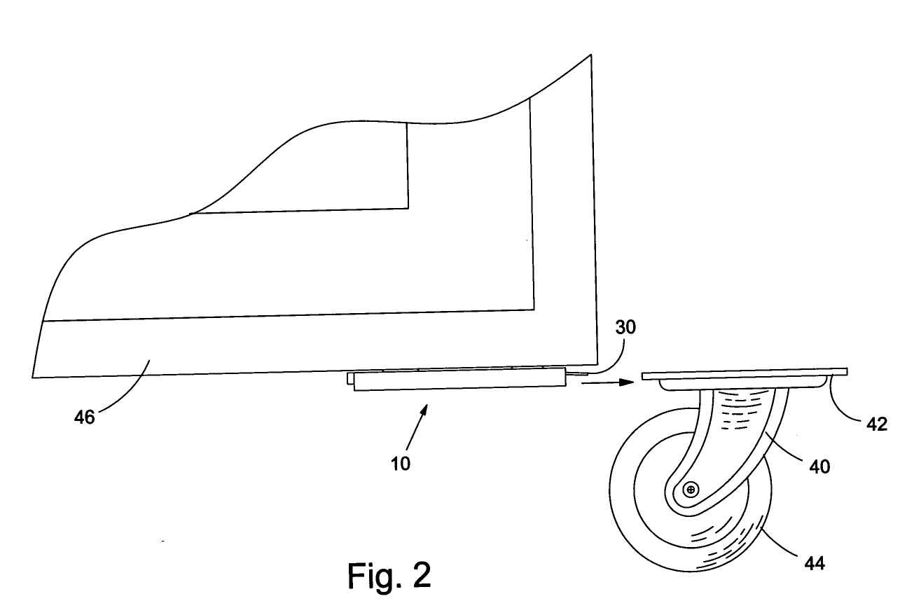

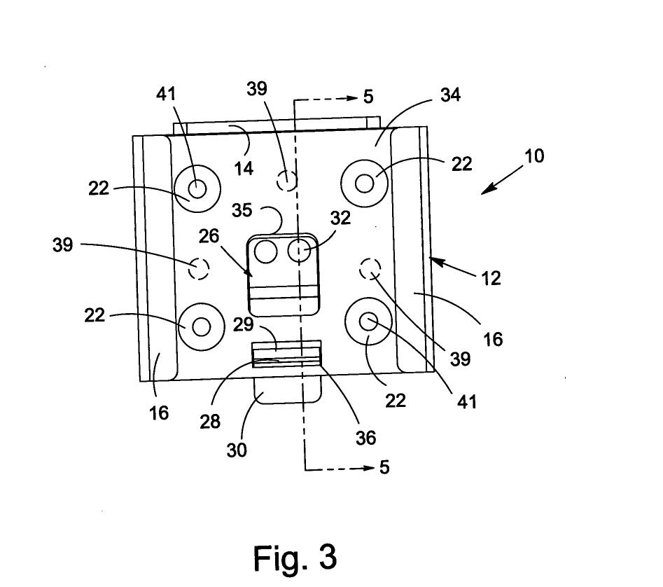

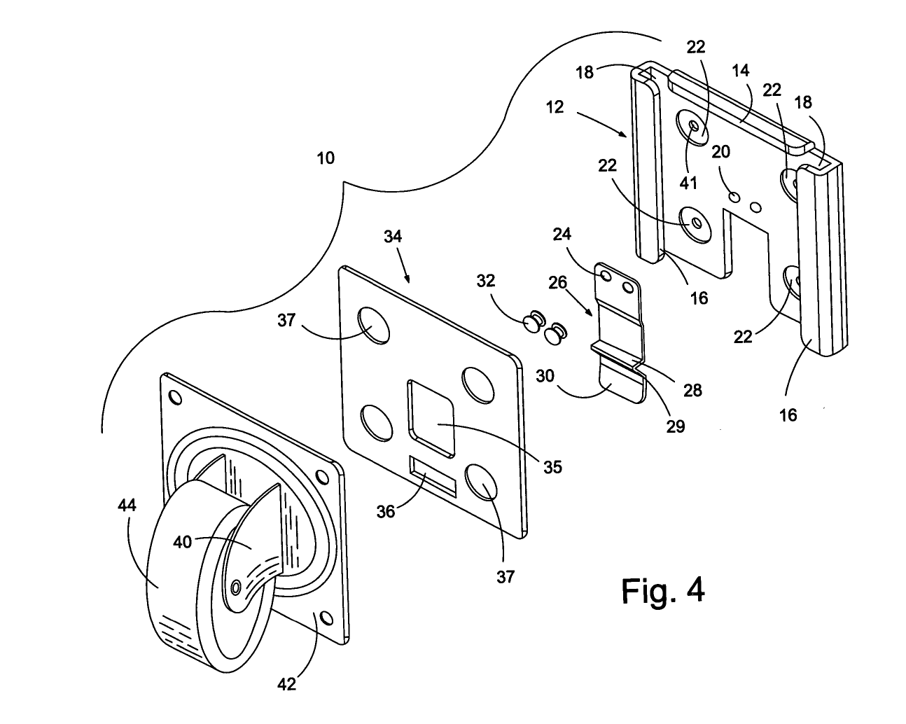

One aspect of the invention is shown by FIG. 1, and designated 10. This is a caster mounting assembly comprising caster bracket 12 having a flexible member 26 (best shown by FIGS. 3-4) affixed to the caster bracket. Caster bracket 12 is typically affixed to the base of an object, such as furniture 46. Caster bracket 12 receives and securely retains caster plate 42 (shown by FIGS. 2 and 4) having affixed thereto caster wheel 44. Wheel 44 can be affixed to the caster plate 42 by known means. For example, by means of an axle through the central axis of the wheel and through wheel bracket 40 affixed to caster plate 42, of conventional design. An exemplary embodiment is shown by FIGS. 1, 2, and 4, wherein wheel 44 is mounted for rotation to wheel bracket 40. Wheel bracket 40 and caster wheel 44 may be affixed to caster plate 42 by means known in the art. For example, wheel bracket 40 may be swivel mounted to caster plate 42 allowing the path of the rotating wheel and object affixed thereto to be readily altered. That is, wheel 44 and wheel bracket 40 may be mounted for 360° rotation, wherein the wheel while turning on its central axis may also rotate about a plane normal to its central axis allowing the path of rotation to be readily altered. Similarly, wheel 44 and bracket 40 may be rigidly mounted to caster plate 42 wherein the path of the rotating wheel is restricted.

Accordingly, the caster mounting assembly 10 of this invention is a universal device allowing flexibility in the installation, removal and replacement of virtually any caster-wheel/caster plate assembly with only hand/finger pressure, and without requiring fastening tools and hardware, such as bolts for securing caster plate 42 to the caster mounting assembly 10.

Features of the present invention enable wheels to be efficiently and easily attached to and removed from furniture 46. FIG. 1 shows wheel 44 attached to the base of furniture 46 through caster mounting assembly 10. FIG. 2 shows wheel 44 in a state of disengagement from caster mounting assembly 10 affixed to the base of furniture 46. When the embodiment of the caster mounting assembly shown in the accompanying Figures is installed on the bottom or base of an object, a user deflects tab 30 by lifting the tab. This disengages locking surface 28 (see FIG. 6) of the flexible member 26 from the edge of caster plate 42. The released caster wheel 44 and caster plate 42 can then be readily withdrawn from caster bracket 12.

Preferably, caster bracket 12 comprises a bracket plate 34 (FIGS. 3-7) seated and affixed to the interior surface of the caster bracket within channels 18 of flanges 16. Plate 34 is affixed to the inside bed of bracket 12 preferably by means of weldments 39 (FIG. 3). Bracket plate 34 comprises slots or cut-outs 35, 36 and 37 (FIG. 4). Slot 36 permits locking surface 28, an elevation of the flexible member 26 to extend through the slot and protrude past the edge of bracket plate 34 for engaging with an edge of the caster plate 42 or a slot or edge of a slot (not shown) in caster plate 42 locking the caster plate and caster wheel securely in-place. Cut-outs 35 and 37 of bracket plate 34 allow access to flexible member 26 and indentations 22 and apertures 41 (FIG. 3) for mounting caster plate 12 to the base of an object.

FIG. 3 is a bottom view of caster bracket 12. As previously disclosed, apertures 41 allow caster bracket 12 to be mounted to furniture 46, for example. Indentations 22 (shown in FIG. 4) allow threaded fasteners (not shown) to be used to affix the caster bracket 12 to the base of furniture 46 while still allowing the caster plate 42 to slide unobstructed within channels 18.

While fasteners 32 or other equivalent means, including weldment(s) may be used for affixing the flexible member 26 to caster bracket 12 in a cantilevered fashion, it will be understood the invention contemplates embodiments wherein the flexible member 26 is integral with the caster bracket 12. Fasteners 32 can be inserted through apertures 20 and 24 to attach flexible member 26 to caster bracket 12. In a preferred embodiment, fasteners 32 are rivets. However, it should be readily apparent to one skilled in the art that other fasteners are possible, and these modifications are intended to be within the spirit and broad scope of the invention, as claimed. Dual flanges 16 form channels 18 (shown in FIGS. 3-4 and 7) for receiving the edges and guiding the caster plate 42 to locking position.

In a preferred embodiment, caster plate 42 is inserted into channels 18 until the caster plate abuts end member 14, a flange or end elevation which performs as a stop. Locking surface 28 of flexible member 26 then engages with the trailing edge of the caster plate 42 securely locking the plate in-place. It should be readily apparent to one skilled in the art that alternative embodiments, such as omitting end member 14 are possible, and these modifications are intended to be within the spirit and broad scope of the invention as claimed.

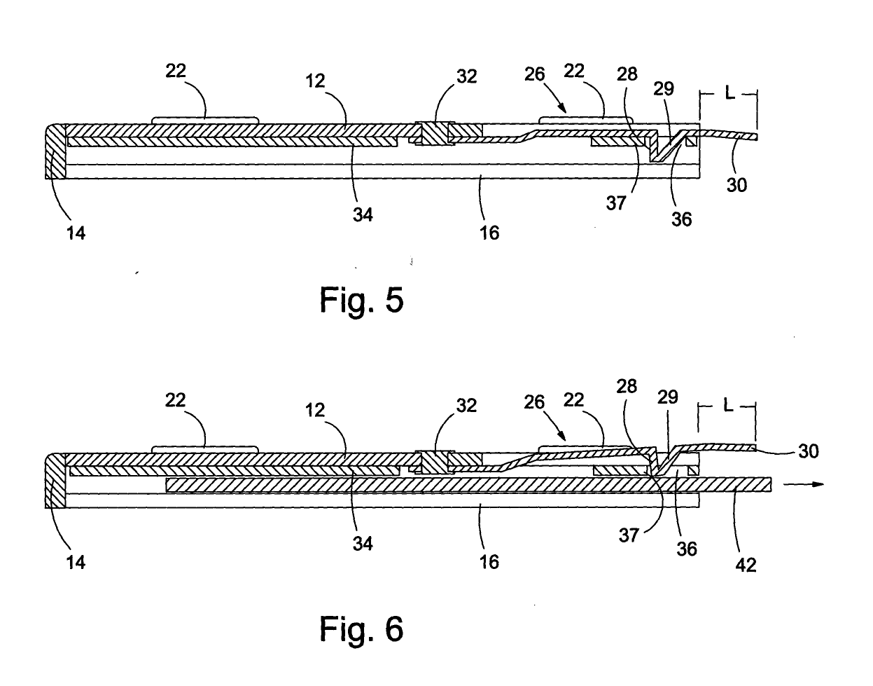

FIG. 5 illustrates the caster bracket assembly 12 of the invention prior to installing of the caster plate 42 and being locked in place by locking surface 28 of flexible member 26. As the caster plate is inserted into channels 18, caster plate 34 engages slanted surface 29, deflecting flexible member 26 away from the caster plate. When the caster plate abuts end member/stop 14, locking surface 28 of the flexible member lines up with the trailing edge of the caster plate allowing the locking surface of flexible member 26 to spring back in-place to lock the caster plate and caster wheel securely in place. If a force is exerted on caster plate 34 in the direction of the arrow on FIG. 6, then locking surface 28 engaged against an edge or slot in the caster plate prevents the caster plate from moving relative to the caster bracket. Thus, the caster plate is immobilized by the flexible member. However, when the caster plate is to be removed, a user deflects flexible member 26 by applying direct hand/finger pressure moving the extended tab 30 upwardly. Locking surface 28 is then released allowing caster plate 42 to move with respect to caster bracket 12, as shown in FIG. 6. Tab 30 shown extended beyond the perimeter of caster bracket 12 allows a user to conveniently and safely access and move tab 30 by applying finger pressure to release caster plate 42 and caster wheels manually without tools. For example, the tab 30 shown in FIGS. 5-6 extends a length L from the perimeter of the caster bracket 12.

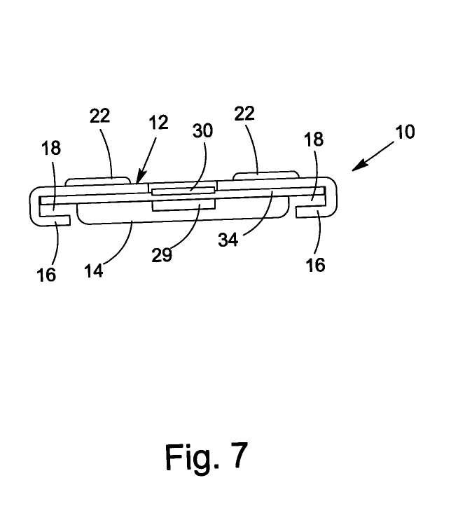

FIG. 7, a frontal/end view of caster bracket 12, showing affixed bracket plate 34 in flush engagement with the bottom surface of the caster bracket, and opposing flanges formed as channels 18 operatively arranged to receive caster plate 42 (FIG. 6).

In a preferred embodiment, flexible member 26 is made of spring steel. However, other materials known in the art may be used, and these modifications are intended to be within the spirit and scope of the invention as claimed.

Thus, it is seen that the objects of the present invention are efficiently obtained, although modifications and changes to the invention should be readily apparent to those having ordinary skill in the art, and these modifications are intended to be within the spirit and scope of the invention as claimed.

1. An apparatus for attaching a wheeled element to a surface of an object comprising a caster bracket with flange means for receiving a connecting plate for said wheeled element, and a flexible member affixed to said caster bracket, said flexible member adapted to substantially immobilize said connecting plate when said flexible member engages a slot or edge of said connecting plate, said flexible member further comprising extension means adapted for direct manual deflection of said flexible member from said slot or edge of said connecting plate and for release of said connecting plate from said caster bracket, said extension means having a length extending past the perimeter of said caster bracket.

2. The apparatus of claim 1, wherein said flexible member comprises a locking surface for engaging an edge of a slot or peripheral edge of said connecting plate, and said extension means comprises a tab member for direct manual compression for release of said connecting plate.

3. The apparatus of claim 1, wherein said caster bracket further comprises a bracket plate seated and affixed to said caster bracket.

4. The apparatus of claim 1, wherein said flexible member engages an edge of said slot in said connecting plate.

5. The apparatus of claim 1, wherein the caster bracket includes means for mounting said bracket to the surface of an object.

6. The apparatus of claim 1, wherein said flexible member is cantilevered and is affixed to said caster bracket with connecting means.

7. The apparatus of claim 1, wherein said flexible member is cantilevered and is integral with said caster bracket.

8. The apparatus of claim 5, wherein said flange means of the caster bracket comprises a plurality of channels.

9. The apparatus of claim 8, wherein said caster bracket further comprises an abutment for engagement by said connecting plate.

10. The apparatus of claim 9, wherein said flexible member engages an edge of said connecting plate when said plate engages said abutment, securing said connecting plate and wheeled element to said caster bracket.

11. The apparatus of claim 1, wherein said connecting plate is a caster plate.

12. The apparatus of claim 1 in combination with a connecting plate and wheeled element.

13. The apparatus of claim 12 wherein said connecting plate and wheeled element are caster plate and caster, respectively.

14. The apparatus of claim 3 in combination with a connecting plate and wheeled element.

15. The apparatus of claim 14 wherein said connecting plate and wheeled element are caster. plate and caster, respectively.

16. The apparatus of claim 6 in combination with a connecting plate and a wheeled element.

17. The apparatus of claim 16 wherein said connecting plate and said wheeled element are caster plate and caster, respectively.

18. A hardware kit comprising the apparatus of claim 1.

19. A hardware kit comprising the apparatus of claim 3.

20. A hardware kit comprising the apparatus of claim 13.

21. A hardware kit comprising the apparatus of claim 15.

22. A hardware kit comprising the apparatus of claim 17.
